(19) United States
(12) Patent Application Publication
(10) Pub. No.: US 2024/0192024 A1
(43) Pub. Date: Jun. 13, 2024

(54) LONG TERM IN-FIELD IMU TEMPERATURE CALIBRATION

(71) Applicant: Snap Inc., Santa Monica, CA (US)

(72) Inventors: Georg Halmetschlager-Funek, Vienna (AT); Jeroen Diederik Hol, Hengelo (NL); Matthias Kalkgruber, Vienna (AT); Tiago Miguel Pereira Torres, Vienna (AT)

(21) Appl. No.: 18/063,450

(22) Filed: Dec. 8, 2022

(51) Int. Cl. G01C 25/00; G01C 21/16; G06F 3/01

(52) U.S. Cl. CPC G01C 25/005; G01C 21/1656; G06F 3/012

(57) ABSTRACT

A method for calibrating a visual-inertial tracking system is described. In one aspect, a method includes measuring a temperature of an inertial measurement unit (IMU) of a visual-inertial tracking system, identifying, from an IMU parametric model of an IMU calibration module, an IMU intrinsic parameter estimate corresponding to the temperature, determining an online IMU intrinsic parameter estimate by operating the visual-inertial tracking system with the IMU intrinsic parameter estimate, providing the online IMU intrinsic parameter estimate to the IMU calibration module, and updating and incorporating the IMU parametric model with the online IMU intrinsic parameter estimate.

### TECHNICAL FIELD

The subject matter disclosed herein generally relates to a visual tracking system. Specifically, the present disclosure addresses systems and methods for calibrating inertial measurement units of visual-inertial tracking systems.

### BACKGROUND

The performance quality of a mixed reality (MR) system typically relies on the accuracy of its calibration parameters, and specifically calibration parameters related to operation of and interoperation between the image sensors and non-image sensors (accelerometers, gyroscopes, magnetometers) of the device implementing the MR system. Currently, most MR systems are calibrated using an averaging technique (sometimes referred to as the “average calibration”) that involves performing a factory calibration of a large number of same-model devices and averaging the resultant calibration parameters of each device. The average parameters are then used for systems that have not been factory calibrated. The average calibration for a given MR system tends to lack precision, particularly when compared to the factory calibration of that MR system. Furthermore, factory calibration parameters can drift over time as the user wears the MR system due to mechanical stress and temperature changes in the MR system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an environment for operating a display device in accordance with one example embodiment.

FIG. 2 is a block diagram illustrating a display device in accordance with one example embodiment.

FIG. 3 is a block diagram illustrating a visual inertial tracking system in accordance with one example embodiment.

FIG. 4 is a block diagram illustrating an IMU calibration module in accordance with one example embodiment.

FIG. 5 is a block diagram illustrating a calibration process in accordance with one example embodiment.

FIG. 6 is a flow diagram illustrating a method for generating a lookup table in accordance with one example embodiment.

FIG. 7 is block diagram showing a software architecture within which the present disclosure may be implemented, according to an example embodiment.

FIG. 8 is a diagrammatic representation of a machine in the form of a computer system within which a set of instructions may be executed for causing the machine to perform any one or more of the methodologies discussed herein, according to one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural Components, such as modules) are optional and may be combined or subdivided, and operations (e.g., in a procedure, algorithm, or other function) may vary in sequence or be combined or subdivided.

The term “MR system” is used herein is inclusive to augmented reality (AR), virtual reality (VR). The term “augmented reality” (AR) refers to an interactive experience of a real-world environment where physical objects that reside in the real-world are “augmented” or enhanced by computer-generated digital content (also referred to as virtual content or synthetic content). AR can also refer to a system that enables a combination of real and virtual worlds, real-time interaction, and 3D registration of virtual and real objects. A user of an AR system perceives virtual content that appears to be attached or interact with a real-world physical object. The term “virtual reality” (VR) refers to a simulation experience of a virtual world environment that is completely distinct from the real-world environment. Computer-generated digital content is displayed in the virtual world environment. VR also refers to a system that enables a user of a VR system to be completely immersed in the virtual world environment and to interact with virtual objects presented in the virtual world environment.

Mixed reality (MR) systems typically employ some form of motion tracking in order to maintain a record of the movement of the MR system with respect to position and orientation as it moves through an area. A visual-inertial odometry (VIO) system is employed to track motion. A MR system uses VIO to estimate, in real-time, its position and orientation (referred to as a “pose”) based on image data captured by one or more image sensors and further based on Inertial Measurement Unit (IMU) data (e.g., a combination of one or more of accelerometer measurements, gyroscope measurements, and magnetometer measurements), obtained via an IMU sensor of the MR system. If an MR system is unable to accurately identify its pose, the quality of the user experience associated with the MR system may be reduced. The quality of the performance of an MR system depends on the accuracy of the calibration parameters of that MR system: calibration parameters related to its VIO system (sometimes referred to herein as “VIO calibration parameters”). The VIO system calibrates sensors of the MR system to accurately determine the pose of the MR system.

Rather than calibrate each individual system at the factory, conventional MR systems rely on an average calibration for setting VIO calibration parameters, where average values of such VIO calibration parameters across respective factory calibrations of multiple MR systems are calculated and then used as the VIO calibration parameters for a given MR system that has not been factory calibrated.

However, compared to a system-specific calibration, such average calibrations typically introduce an undesirable increase in the number of motion tracking errors and tracking failures (including VIO resets and VIO initialization failures, for example). For example, although the tracking system of the MR system can be factory calibrated, extrinsic/intrinsic parameters may change over time (e.g., due to mechanical stress, temperature changes). The tracking system mitigates the changes by gradually updating the parameter values during runtime of an AR/VR application. However, the more the parameter values have diverged from the factory calibration, the longer it takes for the tracking system to “catch up” and obtain an accurate new estimate of the parameter values (e.g., the convergence time becomes longer). Keeping this convergence time short is important, because as long as the estimates are inaccurate, tracking performance is negatively impacted. Furthermore, the parameter values may be used by components other than the tracking system. For applications that rely on these components, it is important that the tracking system operates accurately right from the start (e.g., when the AR/VR application starts or is online).

Accurate positioning can come with high computational costs. IMUs can contribute to higher efficiency and lower-power VIO systems. The better all IMU parameters are known, the better the accuracy of the tracking system. More precise IMU measurements allow to increase the time a system is accurate without external corrections. Hence, accurate IMUs parameters allow for a reduction in computational costs for expensive pose correction that make use of camera images. However, IMU parameters are not constant over time and are influenced by many factors such as temperature. Usually the underlying filtering/optimization algorithms estimate the changing IMU parameters on the fly using a generic model that takes random variations into account. However, changes induced by temperature are systematic and are larger than the non-systematic variations. Since they are systematic, they do not have to be modeled via an imprecise generic model that is meant to estimate smaller non-systematic variations of biases and other intrinsic IMU parameters. It is possible to temperature calibrate IMUs during the manufacturing process of the device. However, calibration at manufacturing requires a significant amount of time and specialized equipment such as large temperature chambers. The present application describes an online estimation process that estimates a temperature model on the fly, using the natural temperature variations a device is exposed to during operation. The online estimation allows to compensate for systematic variations and keeps the part that takes random variations into account as small as possible. Such online estimation enables better IMU performance and unlocks more efficient and accurate VIO algorithms.

The present application describes a method for reducing the convergence time for online parameter estimation at the start of a tracking system. The tracking system measures a current temperature of the IMU and identifies an IMU bias estimate corresponding to the temperature based on a parametric model (e.g., a lookup table). By leveraging the on-the-fly estimation performed in a visual inertial odometry (VIO) system, the tracking system performs online calibration of IMU parameters' dependency on IMU (or tracking system) temperature. The intrinsic parameters are stored when a high degree of accuracy has been achieved with the online estimation. The result is a look-up table/parametric temperature model that can be either used to estimate the IMU bias (or to dynamically adapt the random walk model to compensate for larger errors). Advantages of temperature accurate intrinsic IMU calibration allow for the tracking system to work closer to the correct values and therefore: (1) reduce systematic errors introduced in the tracking system, (2) reduce computational power needed to estimate intrinsic parameters, and (3) provide better positioning accuracy.

In one example embodiment, the present application describes a method for calibrating a visual-inertial tracking system comprising: measuring a temperature of an inertial measurement unit (IMU) of a visual-inertial tracking system, identifying, from an IMU parametric model of an IMU calibration module, an IMU intrinsic parameter estimate corresponding to the temperature, determining an online IMU intrinsic parameter estimate by operating the visual-inertial tracking system with the IMU intrinsic parameter estimate, providing the online IMU intrinsic parameter estimate to the IMU calibration module, and updating and incorporating the IMU parametric model with the online IMU intrinsic parameter estimate.

As a result, one or more of the methodologies described herein facilitate solving the technical problem of power consumption saving and efficient calibration by generating and updating a lookup table for IMU temperature-based bias parameters. The presently described method provides an improvement to an operation of the functioning of a computer by providing power consumption reduction and fastest calibration computation. As such, one or more of the methodologies described herein may obviate a need for certain efforts or computing resources. Examples of such computing resources include processor cycles, network traffic, memory usage, data storage capacity, power consumption, network bandwidth, and cooling capacity.

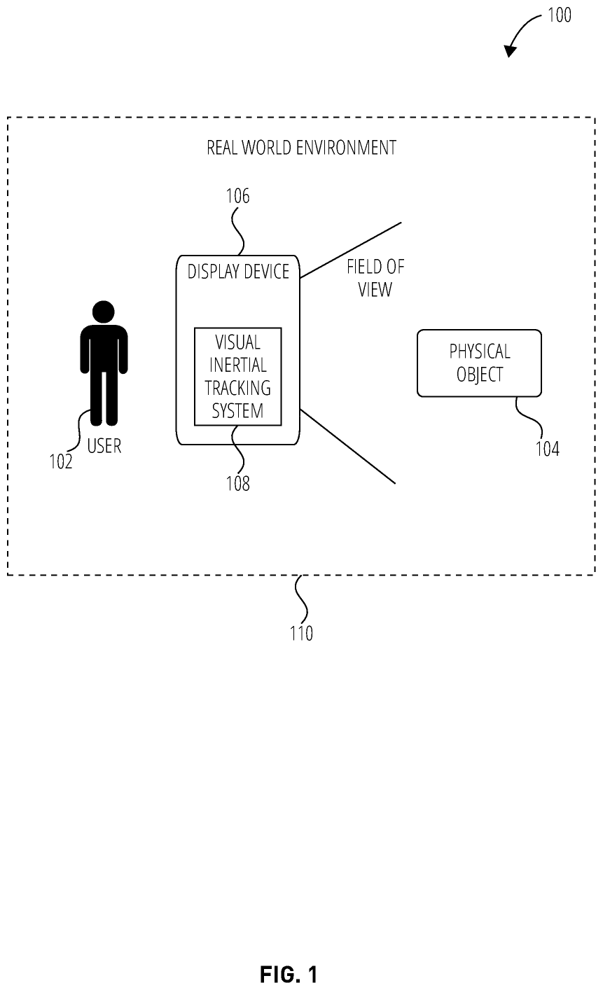

FIG. 1 is a network diagram illustrating an environment 100 suitable for operating a display device 106, according to some example embodiments. The environment 100 includes a user 102, a display device 106, and a physical object 104. A user 102 operates the display device 106. The user 102 may be a human user (e.g., a human being), a machine user (e.g., a computer configured by a software program to interact with the display device 106), or any suitable combination thereof (e.g., a human assisted by a machine, or a machine supervised by a human). The user 102 is associated with the display device 106.

The display device 106 may be a computing device with a display such as a smartphone, a tablet computer, or a wearable computing device (e.g., watch or glasses). The computing device may be hand-held or may be removable mounted to a head of the user 102. In one example, the display includes a screen that displays images captured with a camera of the display device 106. In another example, the display of the device may be transparent such as in lenses of wearable computing glasses. In other examples, the display may be non-transparent, partially transparent, partially opaque. In yet other examples, the display may be wearable by the user 102 to cover the field of vision of the user 102.

The display device 106 includes an AR application that generates virtual content based on images detected with the camera of the display device 106. For example, the user 102 may point a camera of the display device 106 to capture an image of the physical object 104 (e.g., a physical item with visual structures/features). The AR application generates virtual content corresponding to an identified object (e.g., physical object 104) in the image and presents the virtual content in a display of the display device 106.

The display device 106 includes a visual inertial tracking system 108. The visual inertial tracking system 108 tracks the pose (e.g., position and orientation) of the display device 106 relative to the real-world environment 110 using, for example, optical sensors (e.g., depth-enabled 3D camera, image camera), inertial sensors (e.g., gyroscope, accelerometer), wireless sensors (Bluetooth, Wi-Fi), GPS sensor, and audio sensors (e.g., microphone array). In one example, the display device 106 displays virtual content based on the pose of the display device 106 relative to the real-world environment 110 and/or the physical object 104.

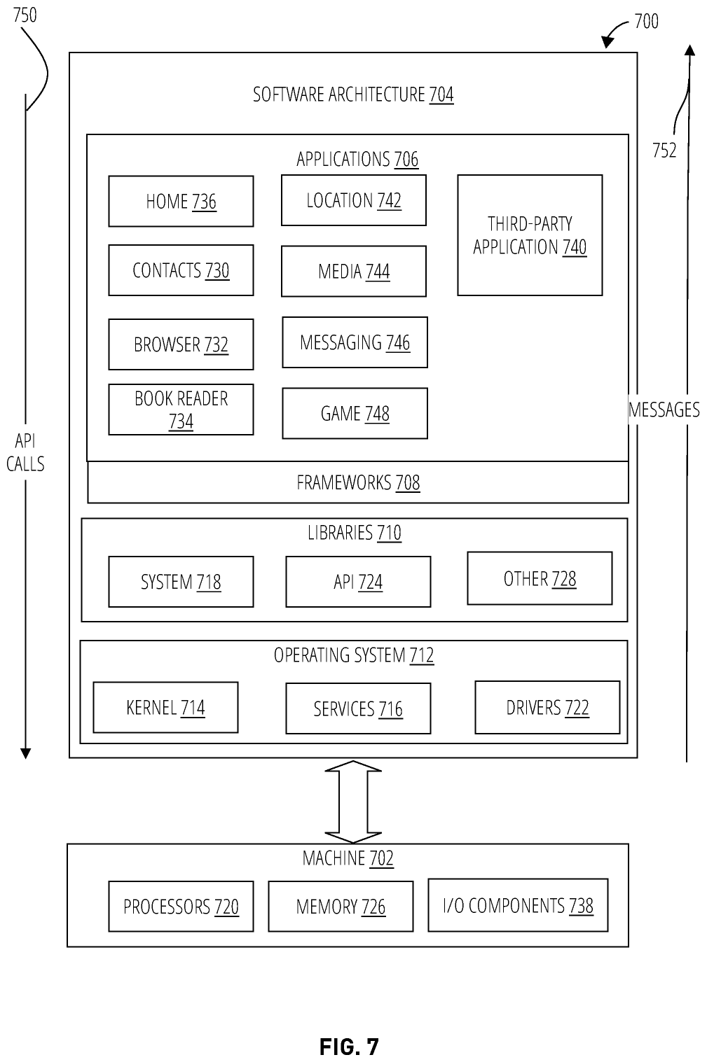

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The display device 106 may operate over a computer network. The computer network may be any network that enables communication between or among machines, databases, and devices. Accordingly, the computer network may be a wired network, a wireless network (e.g., a mobile or cellular network), or any suitable combination thereof. The computer network may include one or more portions that constitute a private network, a public network (e.g., the Internet), or any suitable combination thereof.

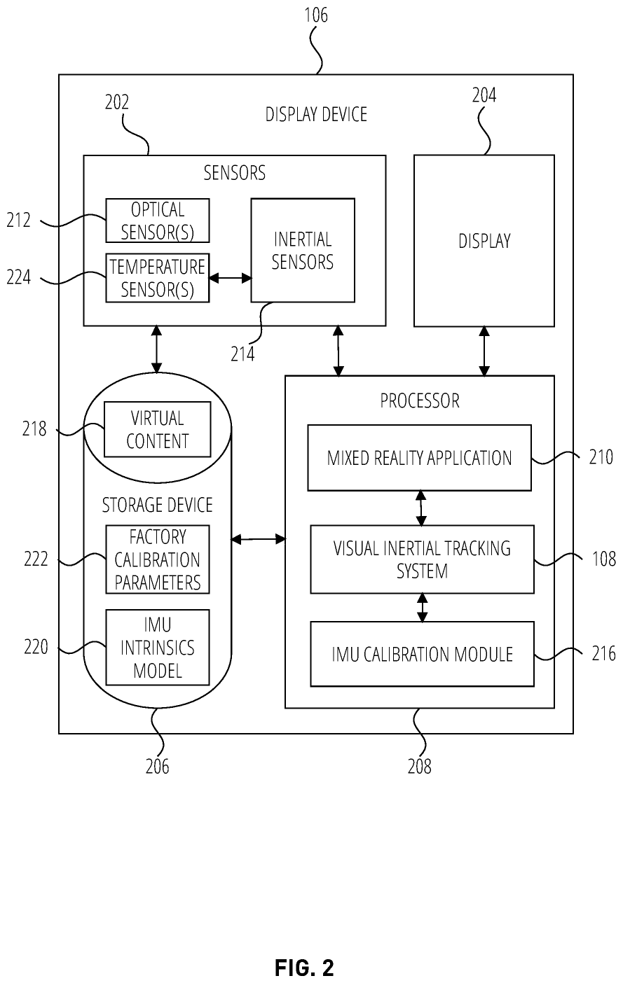

FIG. 2 is a block diagram illustrating modules (e.g., components) of the display device 106, according to some example embodiments. The display device 106 includes sensors 202, a display 204, a processor 208, and a storage device 206. Examples of display device 106 include a wearable computing device, a mobile computing device, a navigational device, a portable media device, or a smart phone.

The sensors 202 include, for example, an optical sensor(s) 212 (e.g., camera such as a color camera, a thermal camera, a depth sensor and one or multiple grayscale, global/rolling shutter tracking cameras), a temperature sensor(s) 224, and inertial sensors 214 (e.g., gyroscope, accelerometer, magnetometer). Other examples of sensors 202 include a proximity or location sensor (e.g., near field communication, GPS, Bluetooth, Wi-Fi), an audio sensor (e.g., a microphone), or any suitable combination thereof. It is noted that the sensors 202 described herein are for illustration purposes and the sensors 202 are thus not limited to the ones described above.

The display 204 includes a screen or monitor configured to display images generated by the processor 208. In one example embodiment, the display 204 may be transparent or semi-opaque so that the user 102 can see through the display 204 (in AR use case). In another example embodiment, the display 204 covers the eyes of the user 102 and blocks out the entire field of view of the user 102 (in VR use case). In another example, the display 204 includes a touchscreen display configured to receive a user input via a contact on the touchscreen display. In other examples, the display device 106 includes a touchpad to receive user input.

The processor 208 includes a mixed reality application 210, a visual inertial tracking system 108, and an IMU calibration module 216. The mixed reality application 210 detects and identifies a physical environment or the physical object 104 using computer vision. The mixed reality application 210 retrieves virtual content (e.g., 3D object model) based on the identified physical object 104 or physical environment. The mixed reality application 210 renders the virtual object in the display 204. In one example embodiment, the mixed reality application 210 includes a local rendering engine that generates a visualization of virtual content overlaid (e.g., superimposed upon, or otherwise displayed in tandem with) on an image of the physical object 104 captured by the optical sensor(s) 212. A visualization of the virtual content may be manipulated by adjusting a position of the physical object 104 (e.g., its physical location, orientation, or both) relative to the optical sensor(s) 212. Similarly, the visualization of the virtual content may be manipulated by adjusting a pose of the display device 106 relative to the physical object 104. For a VR application, the mixed reality application 210 displays the virtual content in the display 204 at a location (in the display 204) determined based on a pose of the display device 106.

The visual inertial tracking system 108 estimates a pose of the display device 106. For example, the visual inertial tracking system 108 uses image data and corresponding inertial data from the optical sensor(s) 212 and the inertial sensors 214 to track a location and pose of the display device 106 relative to a frame of reference (e.g., real world environment 110).

The IMU calibration module 216 calibrates the IMU sensors of inertial sensors 214 based on IMU bias parameter values from an IMU intrinsics model 220. When the mixed reality application 210 operates, the visual inertial tracking system 108 may be referred to as online. When the mixed reality application 210 stops operating, the visual inertial tracking system 108 may be referred to as offline. When the visual inertial tracking system 108 is online, the visual inertial tracking system 108 operates an online estimation of the IMU bias parameters until a new IMU bias estimation is obtained. The IMU calibration module 216 accesses the temperature of the inertial sensors 214 as measured by the temperature sensor(s) 224. The IMU calibration module 216 stores and updates the new IMU bias estimate and the corresponding measured temperature in the IMU intrinsics model 220 in the storage device 206. The IMU calibration module 216 re-uses the latest IMU bias estimate based on the temperature of the IMU as a more up-to-date starting point for another parameter estimation when the visual inertial tracking system 108 operates. Using the new estimation as a starting point for another parameter estimation leads to a reduced convergence time and higher tracking accuracy immediately after the start of the visual inertial tracking system 108.

The storage device 206 stores virtual content 218, the factory calibration parameters 222, and the IMU intrinsics model 220. The virtual content 218 includes, for example, a database of visual references (e.g., images of physical objects) and corresponding experiences (e.g., three-dimensional virtual object models). The IMU intrinsics model 220 include, for example, a lookup table computing the latest IMU bias estimated parameter values and corresponding IMU temperatures for the visual inertial tracking system 108. In one example, the IMU intrinsics model 220 updates the latest bias estimated parameter value based on the latest measured IMU temperature and the latest estimated parameter value.

Any one or more of the modules described herein may be implemented using hardware (e.g., a Processor of a machine) or a combination of hardware and software. For example, any module described herein may configure a Processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

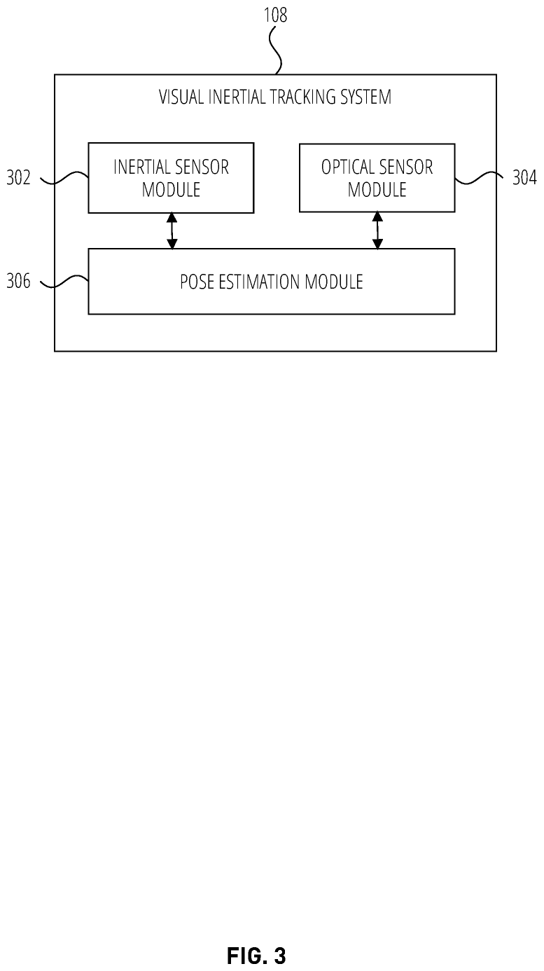

FIG. 3 illustrates the visual inertial tracking system 108 in accordance with one example embodiment. The visual inertial tracking system 108 includes, for example, an inertial sensor module 302, an optical sensor module 304, and a pose estimation module 306. The inertial sensor module 302 accesses inertial sensor data from the inertial sensors 214. The optical sensor module 304 accesses optical sensor data from the optical sensor(s) 212.

The pose estimation module 306 determines a pose (e.g., location, position, orientation) of the display device 106 relative to a frame of reference (e.g., real world environment 110). In one example embodiment, the pose estimation module 306 includes a visual odometry system that estimates the pose of the display device 106 based on 3D maps of feature points from images captured with the optical sensor(s) 212 and the inertial sensor data captured with the inertial sensors 214. The optical sensor module 304 accesses image data from the optical sensor(s) 212.

In one example embodiment, the pose estimation module 306 computes the position and orientation of the display device 106. The display device 106 includes one or more optical sensor(s) 212 mounted on a rigid platform (a frame of the display device 106) with one or more inertial sensors 214. The optical sensor(s) 212 can be mounted with non-overlapping (distributed aperture) or overlapping (stereo or more) fields-of-view.

In some example embodiments, the pose estimation module 306 includes an algorithm that combines inertial information from the inertial sensors 214 and image information from the optical sensor(s) 212 that are coupled to a rigid platform (e.g., display device 106) or a rig. In one embodiment, a rig may consist of multiple cameras mounted on a rigid platform with an inertial navigation unit (e.g., inertial sensors 214). A rig may thus have at least one inertial navigation unit and at least one camera.

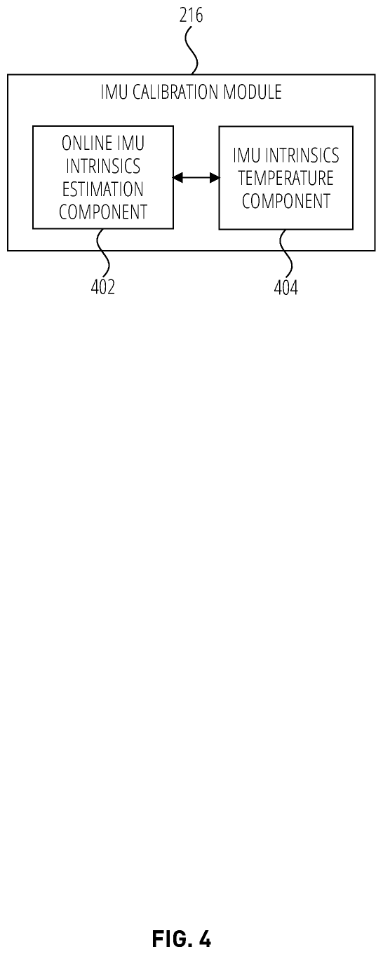

FIG. 4 is a block diagram illustrating an IMU calibration module 216 in accordance with one example embodiment. The IMU calibration module 216 includes an online IMU intrinsics estimation component 402 and an IMU intrinsics temperature component 404.

The online IMU intrinsics estimation component 402 operates the visual inertial tracking system 108 when the mixed reality application 210 operates. In one example embodiment, the online IMU intrinsics estimation component 402 reads a current temperature of the inertial sensors 214 and identifies a latest IMU bias estimate from the IMU intrinsics model 220 based on the measured temperature.

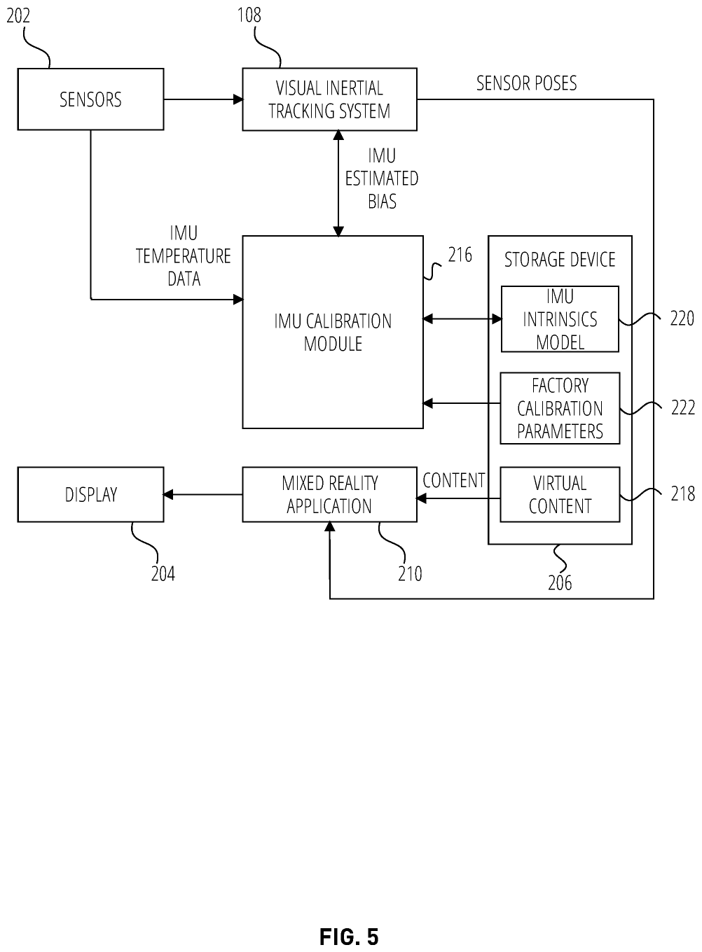

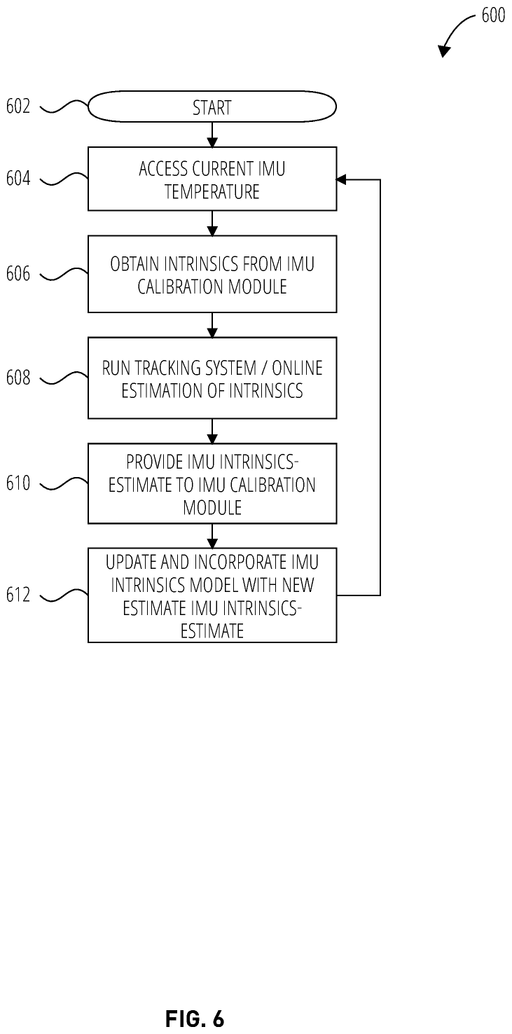

The IMU intrinsics temperature component 404 generates and updates the IMU intrinsics model 220. For example, the IMU intrinsics temperature component 404 determines whether the latest bias estimate (corresponding to a measured temperature of the inertial sensors 214) is still accurate or valid (using the visual inertial tracking system 108 to detect offsets). The IMU intrinsics temperature component 404 runs the visual inertial tracking system 108 for online bias estimation based on either the latest IMU bias estimate (from the IMU intrinsics model 220) or factory calibration bias estimate based on whether the latest bias estimate is still accurate. The IMU intrinsics temperature component 404 updates the IMU intrinsics model 220 when the bias estimate has converged. The operation of IMU intrinsics temperature component 404 is described in more detail below with respect to FIG. 5 and FIG. 6.

FIG. 5 is a block diagram illustrating an example process in accordance with one example embodiment. The visual inertial tracking system 108 receives sensor data from sensors 202 (e.g., inertial sensors 214) to determine a pose of the display device 106. The IMU calibration module 216 detects a current temperature of the inertial sensors 214 from sensors 202.

The IMU calibration module 216 accesses the IMU bias estimate corresponding to the current temperature of the inertial sensors 214 from IMU intrinsics model 220. The IMU calibration module 216 determines whether the IMU bias estimate is still accurate or valid. If the IMU bias estimate is no longer valid, the IMU calibration module 216 retrieves the factory calibration parameters 222 (e.g., IMU factory calibration). The IMU calibration module 216 runs the visual inertial tracking system 108 for online bias estimation and to detect whether the IMU bias estimate has converged. Once converged, the IMU calibration module 216 stores and updates the converged bias estimate for the measured temperature in the IMU intrinsics model 220.

The IMU calibration module 216 calibrates the sensor data (from inertial sensors 214) based on the IMU bias estimate corresponding to the measured IMU temperature from the IMU intrinsics model 220. The mixed reality application 210 retrieves virtual content 218 from the storage device 206 and causes the virtual content 218 to be displayed at a location based on the geometric model of the display device 106.

FIG. 6 illustrates an example routine 600 for updating and incorporating IMU intrinsics model. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

Operations in the routine 600 may be performed by the visual inertial tracking system 108, using Components (e.g., modules, engines) described above with respect to FIG. 2. Accordingly, the routine 600 is described by way of example with reference to the IMU calibration module 216. However, it shall be appreciated that at least some of the operations of the routine 600 may be deployed on various other hardware configurations or be performed by similar Components residing elsewhere.

According to some examples, the method includes starting at start 602, accessing current IMU temperature at block 604, obtaining intrinsics from IMU calibration module at block 606, running tracking system/online estimation of intrinsics at block 608, providing the IMU intrinsics-estimate to IMU calibration module at block 610, and updating and incorporate IMU intrinsics model with new estimate IMU intrinsics-estimate at block 612.

FIG. 7 is a block diagram 700 illustrating a software architecture 704, which can be installed on any one or more of the devices described herein. The software architecture 704 is supported by hardware such as a machine 702 that includes Processors 720, memory 726, and I/O Components 738. In this example, the software architecture 704 can be conceptualized as a stack of layers, where each layer provides a particular functionality. The software architecture 704 includes layers such as an operating system 712, libraries 710, frameworks 708, and applications 706. Operationally, the applications 706 invoke API calls 750 through the software stack and receive messages 752 in response to the API calls 750.

The operating system 712 manages hardware resources and provides common services. The operating system 712 includes, for example, a kernel 714, services 716, and drivers 722. The kernel 714 acts as an abstraction layer between the hardware and the other software layers. For example, the kernel 714 provides memory management, Processor management (e.g., scheduling), Component management, networking, and security settings, among other functionalities. The services 716 can provide other common services for the other software layers. The drivers 722 are responsible for controlling or interfacing with the underlying hardware. For instance, the drivers 722 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 710 provide a low-level common infrastructure used by the applications 706. The libraries 710 can include system libraries 718 (e.g., C standard library) that provide functions such as memory allocation functions, string manipulation functions, mathematic functions, and the like. In addition, the libraries 710 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 710 can also include a wide variety of other libraries 728 to provide many other APIs to the applications 706.

The frameworks 708 provide a high-level common infrastructure that is used by the applications 706. For example, the frameworks 708 provide various graphical user interface (GUI) functions, high-level resource management, and high-level location services. The frameworks 708 can provide a broad spectrum of other APIs that can be used by the applications 706, some of which may be specific to a particular operating system or platform.

In an example embodiment, the applications 706 may include a home application 736, a contacts application 730, a browser application 732, a book reader application 734, a location application 742, a media application 744, a messaging application 746, a game application 748, and a broad assortment of other applications such as a third-party application 740. The applications 706 are programs that execute functions defined in the programs. Various programming languages can be employed to create one or more of the applications 706, structured in a variety of manners, such as object-oriented programming languages (e.g., Objective-C, Java, or C++) or procedural programming languages (e.g., C or assembly language). In a specific example, the third-party application 740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 740 can invoke the API calls 750 provided by the operating system 712 to facilitate functionality described herein.

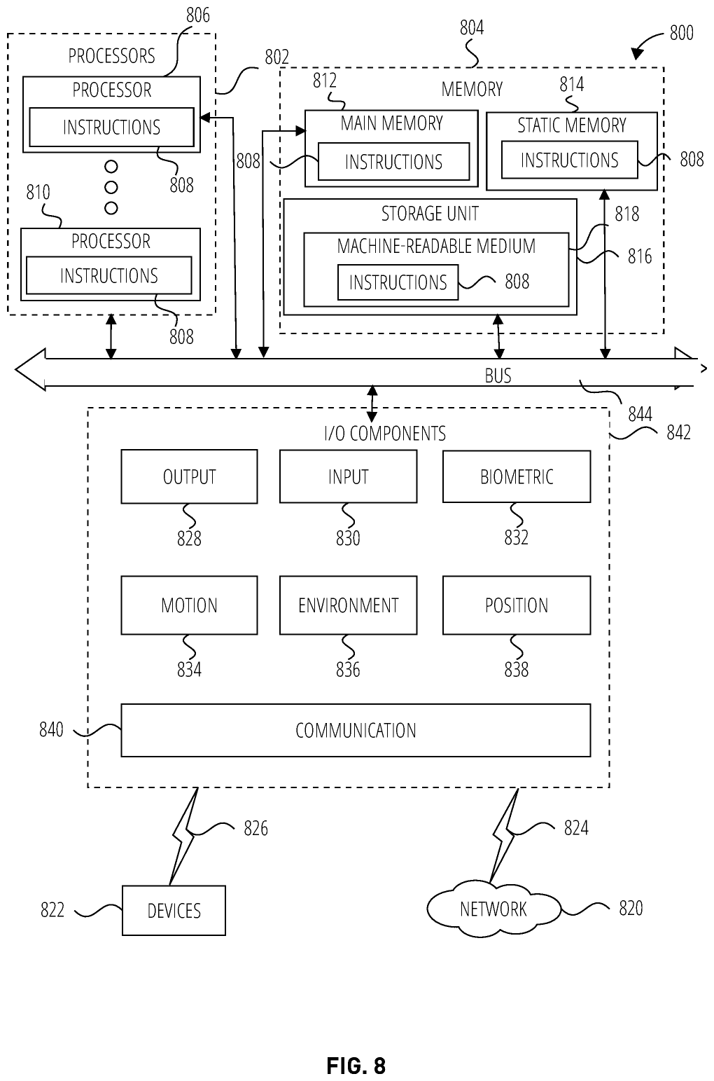

FIG. 8 is a diagrammatic representation of the machine 800 within which instructions 808 (e.g., software, a program, an application, an applet, an app, or other executable code) for causing the machine 800 to perform any one or more of the methodologies discussed herein may be executed. For example, the instructions 808 may cause the machine 800 to execute any one or more of the methods described herein. The instructions 808 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 808, sequentially or otherwise, that specify actions to be taken by the machine 800. Further, while only a single machine 800 is illustrated, the term “machine” shall also be taken to include a collection of machines that individually or jointly execute the instructions 808 to perform any one or more of the methodologies discussed herein.

The machine 800 may include Processors 802, memory 804, and I/O components 842, which may be configured to communicate with each other via a bus 844. In an example embodiment, the Processors 802 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 806 and a Processor 810 that execute the instructions 808. The term “Processor” is intended to include multi-core Processors that may comprise two or more independent Processors (sometimes referred to as “cores”) that may execute instructions contemporaneously. Although FIG. 8 shows multiple Processors 802, the machine 800 may include a single Processor with a single core, a single Processor with multiple cores (e.g., a multi-core Processor), multiple Processors with a single core, multiple Processors with multiples cores, or any combination thereof.

The memory 804 includes a main memory 812, a static memory 814, and a storage unit 816, both accessible to the Processors 802 via the bus 844. The main memory 804, the static memory 814, and storage unit 816 store the instructions 808 embodying any one or more of the methodologies or functions described herein. The instructions 808 may also reside, completely or partially, within the main memory 812, within the static memory 814, within machine-readable medium 818 within the storage unit 816, within at least one of the Processors 802 (e.g., within the Processor's cache memory), or any suitable combination thereof, during execution thereof by the machine 800.

The I/O components 842 may include a wide variety of Components to receive input, provide output, produce output, transmit information, exchange information, capture measurements, and so on. The specific I/O components 842 that are included in a particular machine will depend on the type of machine. For example, portable machines such as mobile phones may include a touch input device or other such input mechanisms, while a headless server machine will likely not include such a touch input device. It will be appreciated that the I/O components 842 may include many other Components that are not shown in FIG. 8. In various example embodiments, the I/O components 842 may include output components 828 and input components 830. The output components 828 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input components 830 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O components 842 may include biometric components 832, motion components 834, environmental components 836, or position components 838, among a wide array of other Components. For example, the biometric components 832 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 include acceleration sensor components (e.g., accelerometer), gravitation sensor components, rotation sensor components (e.g., gyroscope), and so forth. The environmental components 836 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 842 further include communication components 840 operable to couple the machine 800 to a network 820 or devices 822 via a coupling 824 and a coupling 826, respectively. For example, the communication components 840 may include a network interface Component or another suitable device to interface with the network 820. In further examples, the communication components 840 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 822 may be another machine or any of a wide variety of peripheral devices (e.g., a peripheral device coupled via a USB).

Moreover, the communication components 840 may detect identifiers or include Components operable to detect identifiers. For example, the communication components 840 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication components 840, such as location via Internet Protocol (IP) geolocation, location via Wi-Fi® signal triangulation, location via detecting an NFC beacon signal that may indicate a particular location, and so forth.

The various memories (e.g., memory 804, main memory 812, static memory 814, and/or memory of the Processors 802) and/or storage unit 816 may store one or more sets of instructions and data structures (e.g., software) embodying or used by any one or more of the methodologies or functions described herein. These instructions (e.g., the instructions 808), when executed by Processors 802, cause various operations to implement the disclosed embodiments.

The instructions 808 may be transmitted or received over the network 820, using a transmission medium, via a network interface device (e.g., a network interface Component included in the communication components 840) and using any one of a number of well-known transfer protocols (e.g., hypertext transfer protocol (HTTP)). Similarly, the instructions 808 may be transmitted or received using a transmission medium via the coupling 826 (e.g., a peer-to-peer coupling) to the devices 822.

### Examples

Example 1 is a method comprising: measuring a temperature of an inertial measurement unit (IMU) of a visual-inertial tracking system; identifying, from an IMU parametric model of an IMU calibration module, an IMU intrinsic parameter estimate corresponding to the temperature; determining an online IMU intrinsic parameter estimate by operating the visual-inertial tracking system with the IMU intrinsic parameter estimate; providing the online IMU intrinsic parameter estimate to the IMU calibration module; and updating and incorporating the IMU parametric model with the online IMU intrinsic parameter estimate.

Example 2 includes the method of example 1, further comprising: storing, in the IMU parametric model, the online IMU intrinsic parameter estimate and the temperature.

Example 3 includes the method of example 1, further comprising: storing the IMU parametric model in a storage device of the visual-inertial tracking system.

Example 4 includes the method of example 1, wherein updating and incorporating the IMU parametric model includes: updating the IMU intrinsic parameter estimate corresponding to the temperature with the online IMU intrinsic parameter estimate.

Example 5 includes the method of example 2, wherein the IMU parametric model includes a look-up table, wherein the look-up table maps the IMU intrinsic parameter estimate to the temperature.

Example 6 includes the method of example 1, wherein the IMU parametric model includes an IMU temperature model.

Example 7 includes the method of example 1, wherein the online IMU intrinsic parameter estimate includes an online IMU bias estimate.

Example 8 includes the method of example 1, wherein measuring the temperature of the IMU includes measuring the temperature of the IMU of the visual-inertial tracking system during an operation of the visual-inertial tracking system.

Example 9 includes the method of example 1, wherein measuring the temperature of the IMU includes periodically measuring the temperature of the IMU of the visual-inertial tracking system.

Example 10 includes the method of example 1, wherein the visual-inertial tracking system is part of an augmented reality display device.

Example 11 is a computing apparatus comprising: a processor; and a memory storing instructions that, when executed by the processor, configure the apparatus to: measure a temperature of an inertial measurement unit (IMU) of a visual-inertial tracking system; identify, from an IMU parametric model of an IMU calibration module, an IMU intrinsic parameter estimate corresponding to the temperature; determine an online IMU intrinsic parameter estimate by operating the visual-inertial tracking system with the IMU intrinsic parameter estimate; provide the online IMU intrinsic parameter estimate to the IMU calibration module; and update and incorporate the IMU parametric model with the online IMU intrinsic parameter estimate.

Example 12 includes the computing apparatus of example 11, wherein the instructions further configure the apparatus to: store, in the IMU parametric model, the online IMU intrinsic parameter estimate and the temperature.

Example 13 includes the computing apparatus of example 11, wherein the instructions further configure the apparatus to: store the IMU parametric model in a storage device of the visual-inertial tracking system.

Example 14 includes the computing apparatus of example 11, wherein updating and incorporate the IMU parametric model includes: update the IMU intrinsic parameter estimate corresponding to the temperature with the online IMU intrinsic parameter estimate.

Example 15 includes the computing apparatus of example 12, wherein the IMU parametric model includes a look-up table, wherein the look-up table maps the IMU intrinsic parameter estimate to the temperature.

Example 16 includes the computing apparatus of example 11, wherein the IMU parametric model includes an IMU temperature model.

Example 17 includes the computing apparatus of example 11, wherein the online IMU intrinsic parameter estimate includes an online IMU bias estimate.

Example 18 includes the computing apparatus of example 11, wherein measure the temperature of the IMU includes measuring the temperature of the IMU of the visual-inertial tracking system during an operation of the visual-inertial tracking system.

Example 19 includes the computing apparatus of example 11, wherein measuring the temperature of the IMU includes periodically measuring the temperature of the IMU of the visual-inertial tracking system.

Example 20 is a non-transitory computer-readable storage medium, the computer-readable storage medium including instructions that when executed by a computer, cause the computer to: measure a temperature of an inertial measurement unit (IMU) of a visual-inertial tracking system; identify, from an IMU parametric model of an IMU calibration module, an IMU intrinsic parameter estimate corresponding to the temperature; determine an online IMU intrinsic parameter estimate by operating the visual-inertial tracking system with the IMU intrinsic parameter estimate; provide the online IMU intrinsic parameter estimate to the IMU calibration module; and update and incorporate the IMU parametric model with the online IMU intrinsic parameter estimate.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
measuring a temperature of an inertial measurement unit (IMU) of a visual-inertial tracking system;
identifying, from an IMU parametric model of an IMU calibration module, an IMU intrinsic parameter estimate corresponding to the temperature;
determining an online IMU intrinsic parameter estimate by operating the visual-inertial tracking system with the IMU intrinsic parameter estimate;
providing the online IMU intrinsic parameter estimate to the IMU calibration module; and
updating and incorporating the IMU parametric model with the online IMU intrinsic parameter estimate.

2. The method of claim 1, further comprising:
storing, in the IMU parametric model, the online IMU intrinsic parameter estimate and the temperature.

3. The method of claim 1, further comprising:
storing the IMU parametric model in a storage device of the visual-inertial tracking system.

4. The method of claim 1, wherein updating and incorporating the IMU parametric model includes:
updating the IMU intrinsic parameter estimate corresponding to the temperature with the online IMU intrinsic parameter estimate.

5. The method of claim 2, wherein the IMU parametric model includes a look-up table,
wherein the look-up table maps the IMU intrinsic parameter estimate to the temperature.

6. The method of claim 1, wherein the IMU parametric model includes an IMU temperature model.

7. The method of claim 1, wherein the online IMU intrinsic parameter estimate includes an online IMU bias estimate.

8. The method of claim 1, wherein measuring the temperature of the IMU includes measuring the temperature of the IMU of the visual-inertial tracking system during an operation of the visual-inertial tracking system.

9. The method of claim 1, wherein measuring the temperature of the IMU includes periodically measuring the temperature of the IMU of the visual-inertial tracking system.

10. The method of claim 1, wherein the visual-inertial tracking system is part of an augmented reality display device.

11. A computing apparatus comprising:
a processor; and
a memory storing instructions that, when executed by the processor, configure the apparatus to:
measure a temperature of an inertial measurement unit (IMU) of a visual-inertial tracking system;
identify, from an IMU parametric model of an IMU calibration module, an IMU intrinsic parameter estimate corresponding to the temperature;
determine an online IMU intrinsic parameter estimate by operating the visual-inertial tracking system with the IMU intrinsic parameter estimate;
provide the online IMU intrinsic parameter estimate to the IMU calibration module; and
update and incorporate the IMU parametric model with the online IMU intrinsic parameter estimate.

12. The computing apparatus of claim 11, wherein the instructions further configure the apparatus to:
store, in the IMU parametric model, the online IMU intrinsic parameter estimate and the temperature.

13. The computing apparatus of claim 11, wherein the instructions further configure the apparatus to:
store the IMU parametric model in a storage device of the visual-inertial tracking system.

14. The computing apparatus of claim 11, wherein updating and incorporate the IMU parametric model includes:
update the IMU intrinsic parameter estimate corresponding to the temperature with the online IMU intrinsic parameter estimate.

15. The computing apparatus of claim 12, wherein the IMU parametric model includes a look-up table,
wherein the look-up table maps the IMU intrinsic parameter estimate to the temperature.

16. The computing apparatus of claim 11, wherein the IMU parametric model includes an IMU temperature model.

17. The computing apparatus of claim 11, wherein the online IMU intrinsic parameter estimate includes an online IMU bias estimate.

18. The computing apparatus of claim 11, wherein measure the temperature of the IMU includes measuring the temperature of the IMU of the visual-inertial tracking system during an operation of the visual-inertial tracking system.

19. The computing apparatus of claim 11, wherein measuring the temperature of the IMU includes periodically measuring the temperature of the IMU of the visual-inertial tracking system.

20. A non-transitory computer-readable storage medium, the computer-readable storage medium including instructions that when executed by a computer, cause the computer to:
measure a temperature of an inertial measurement unit (IMU) of a visual-inertial tracking system;
identify, from an IMU parametric model of an IMU calibration module, an IMU intrinsic parameter estimate corresponding to the temperature;
determine an online IMU intrinsic parameter estimate by operating the visual-inertial tracking system with the IMU intrinsic parameter estimate;
provide the online IMU intrinsic parameter estimate to the IMU calibration module; and
update and incorporate the IMU parametric model with the online IMU intrinsic parameter estimate.
